(19) United States
(12) Patent Application Publication
(10) Pub. No.: US 2025/0291227 A1
(43) Pub. Date: Sep. 18, 2025

(54) OPTICAL BEAM SCULPTING ASSEMBLY

(71) Applicant: ADVANCED MICRO FOUNDRY PTE. LTD., Singapore (SG)

(72) Inventors: You Sian James TAN, Singapore (SG); Xianshu LUO, Singapore (SG)

(73) Assignee: ADVANCED MICRO FOUNDRY PTE. LTD., Singapore (SG)

(21) Appl. No.: 18/860,765

(22) PCT Filed: Aug. 8, 2022
(86) PCT No.: PCT/SG2022/050568

§ 371 Date: Oct. 28, 2024

(51) Int. Cl. G02F 1/29; G01S 7/481

(52) U.S. Cl. CPC G02F 1/292; G01S 7/4814; G01S 7/4817

(57) ABSTRACT

An optical beam sculpting assembly defines optical beam characteristics of an optical beam, and comprises a chip substrate, a beam forming and steering structure positioned on the chip substrate, adapted to emit, to receive, and/or to steer the optical beams, and at least one phase mask, with each phase mask having at least one corresponding core having a thickness, and a height. The beam forming and steering structure is positioned between the at least one phase mask and the chip substrate, and the at least one phase mask is configured to modify the optical beam characteristics of the optical beam. The optical beam characteristic comprises at least one of a spatial distribution of optical amplitude, a temporal distribution of optical amplitude, an optical phase, a polarization, and an optical orbital angular momentum.

### FIELD OF THE INVENTION

The present invention relates to the field of integrated photonics, target tracking and ranging, data processing and remote sensing using an optical phased array, and more particularly to optical beam sculpting assemblies having stacked phase masks positioned on or integrated to a beam forming and steering structure (such as an optical phased array or a focal plane switch array).

### BACKGROUND OF THE INVENTION

Photonic components can be used to form and steer optical beams, as well as define beam characteristics. The beam characteristics can have spatial and/or temporal distributions of optical amplitude, optical phase, polarization and optical orbital angular momentum (OAM). For example, by being able to precisely define the vectorial properties of an optical beam, spatial multiplexing of OAM information-carrying beam for free-space transceivers can be realised. The ability to reliably define and alter the beam characteristics is particularly useful in applications such as light detection and ranging (LiDAR) systems and free-space transceivers.

The use of the same structure or set of structures/components, to concurrently form, steer and define the characteristics of the beam inherently comes with trade-offs. Known beam forming and steering structures that often work in the visible, near- and short-wavelength infrared region, include beam emitters constructed from mechanical free-space optical components (e.g., mirrors, prisms and lenses), liquid crystals, and phase change materials. It can be difficult to define the optical beam characteristics directly from the beam emitters (for example, from an optical phased array OPA or a focal plane switch array FPSA). Figure-of-merits of beam emitters, such as field-of-view and spot size, are challenging to simultaneously address via physical design of beam emitters alone.

An example of such a set of beam emitting structures to form and steer an optical beam using focal plane switch array (FPSA) is reported in Chang et al., Opt. Exp. 29, 2021. Chang et al. discloses photonic components for beam forming and steering formed from three main components: a set of Mach-Zehnder optical switches, microring emitters, and metalens. The metalens in Chang et al. is an integral part of FPSA for beam forming and steering. Each of the components are requisites to beam steering, without which beam steering cannot take place. The optical switches determine the microring emitters that are activated. The optical beam from the activated microring emitter is steered to a certain direction by the metalens. Because the resulting optical beam in the far field is due to Fraunhofer diffraction (and not beam focusing, for example by the lens), the spatial width of the far field optical beam increases as the distance between the beam emitter and beam detection plane increases, as is the case in other beam emitters. It is desirable to provide an improved photonic component to redefine and modify the beam characteristics of optical beam from a beam forming and steering structure (for example, from an OPA or FPSA).

### SUMMARY OF THE INVENTION

In accordance with a first aspect, an optical beam sculpting assembly defines optical beam characteristics of an optical beam, and comprises a chip substrate, a beam forming and steering structure (for example an optical phased array (OPA) or focal plane switch array (FPSA)) positioned on the chip substrate, adapted to emit, to receive, and/or to steer the optical beams, and at least one phase mask, with each phase mask having at least one corresponding core having a thickness, and a height. The beam forming and steering structure is positioned between the at least one phase mask and the chip substrate, and the at least one phase mask is configured to modify the optical beam characteristics of the optical beam. The optical beam characteristic comprises at least one of a spatial distribution of optical amplitude, a temporal distribution of optical amplitude, an optical phase, a polarization, and an optical orbital angular momentum.

From the foregoing disclosure and following more detailed description of various embodiments it will be apparent to those skilled in the art that the present invention provides a significant advance in the technology to redefine and modify the beam from beam emitters. Particularly significant in this regard is the potential the invention affords for providing a beam forming and steering structure with the controlled beam characteristics. Additional features and advantages of various embodiments will be better understood in view of the detailed description provided below.

### BRIEF DESCRIPTION OF THE DRAWINGS

FIG. 1 illustrates a schematic of an optical beam sculpting assembly showing stacked layers, in accordance with an embodiment;

FIG. 2 is a table showing the different types of optical phase masks, in accordance with several embodiments;

FIG. 3 is a schematic isometric view of a discrete binary phase mask for defining the beam characteristics of optical beam, in accordance with one embodiment;

FIG. 4 is a schematic isometric view of a phase mask unit cell, in accordance with one embodiment;

FIG. 5 shows a schematic diagram showing beam directionality shifting using the phase mask stacks, in accordance with certain embodiments disclosed herein;

FIG. 6 is a table showing variations in an estimated resulting z-component of electric field (E_{z}) field profiles of additional embodiments of the photonic components at Δφ=30° along an xz-cross section;

FIG. 7 is a table showing variations in an estimated resulting z-component of electric field (E_{z}) field profiles of additional embodiments of the photonic components at Δφ=60° along an xz-cross section disclosed;

FIG. 8 is a table showing variations in an estimated resulting z-component of electric field (E_{z}) field profiles of additional embodiments of the photonic components at Δφ=−120° along an xz-cross section;

FIG. 9 is a table showing schematic diagrams of beam focusing using the phase mask stack layers, in accordance with an embodiment disclosed herein;

FIG. 10 shows an estimated resulting electric field magnitude of the optical field from an optical beam sculpting assembly, in accordance with an embodiment herein; and

FIG. 11 is a table showing a representative combination of beam directionality shifting and beam focusing, and an estimated resulting electric field magnitude of the optical field from the optical beam sculpting assembly.

It should be understood that the appended drawings are not necessarily to scale, presenting a somewhat simplified representation of various features illustrative of the basic principles of the invention. The specific design features of the beam forming and steering structure as disclosed here, including, for example, the specific dimensions of the phase mask layers, will be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many use and design variations are possible for the optical beam sculpting assemblies disclosed herein. The following detailed discussion of various alternate features and embodiments illustrates the general principles of the invention with reference to an optical beam sculpting assembly suitable for redefining and modifying beam characteristics from the beam forming and steering structure, especially wide-angle beam steering. Other embodiments suitable for other applications will be apparent to those skilled in the art given the benefit of this disclosure.

Disclosed herein are optical beam sculpting assemblies to modify beam characteristics comprising a phase mask stack 120 mounted on a beam forming and steering structure that is positioned on a chip substrate. The optical beam sculpting assemblies comprises the beam forming and steering structure and the phase masks. The beam forming and steering structure may comprise multiple components for beam forming and beam steering, for example distinct components to form an optical beam, and to steer an optical beam. These distinct components can be integrated onto the same platform, such as that in Chang et al., Opt. Exp. 29, 2021. The phase mask stack 120 advantageously provides the ability to adjust the characteristics of the beam from the beam forming and steering structure, including but not limited to either or both spatial and temporal distributions of optical amplitude, optical phase, polarization, optical OAM. The phase masks can comprise, for example, any of silicon (Si), polysilicon, silicon nitride (Si₃N₄), silicon dioxide, germanium (Ge), lithium niobate (Li₃NbO₃) a polymer, a III-V compound (that is, an alloy containing elements from Groups III and V in the periodic table, and a II-VI compound (that is, an alloy containing elements from Groups II and VI in the Periodic Table).

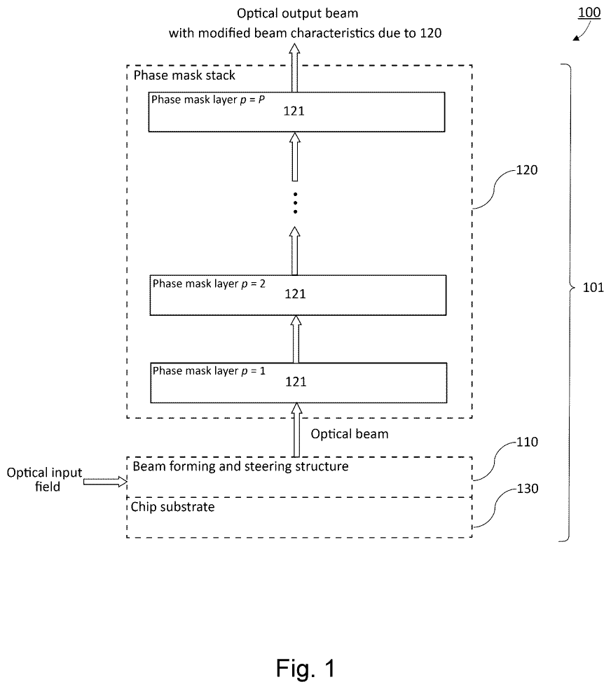

Referring to FIG. 1, a schematic block diagram 100 of an optical beam sculpting assembly 101 is disclosed which comprises at least one phase mask (P≥1) 121 of a phase mask stack 120 mounted above a beam forming and steering structure 110 which is positioned on the chip substrate 130. Each beam forming and steering structure 110 can comprise an array with beam emitters. There can be any arbitrary number of phase masks based on a configuration of the optical beam sculpting assembly 101 selected for an application. Optical input field is sent to the beam emitters on the beam forming and steering structure 110 which are positioned on the chip substrate 130. Beam characteristics of the resulting optical beam from the array of beam emitters in 110 is defined by the phase mask stack 120. The beam emitters in 110 can comprise structures that induce optical scattering (such as grating structures) to collectively generate an optical beam, for example.

As seen in FIG. 1, the phase mask stack p=1, p=2, . . . , p=P 121 are vertically stacked on top of one another. For instance, the first phase mask p=1 is vertically stacked over by the second phase mask p=2, and the second phase mask p=2 is stacked over by the third phase mask p=3. The first phase mask p=1 is positioned above the beam forming and steering structure 110, which is in turn positioned on the chip substrate 130. The phase masks p=1, p=2, . . . , p=P 121, and the beam forming and steering structure 110 are shown aligned on the chip substrate 130. Each phase masks can comprise periodically placed structures (cores/pillars) having an elliptical, a polygonal, or a closed Bezier curve cross section, and separated by a distance and can be formed as unit cells, as discussed in greater detail below. The phase masks are configured to modify the optical beam characteristics of the optical beam. Such optical beam characteristic comprises at least one of a spatial distribution of optical amplitude, a temporal distribution of optical amplitude, an optical phase, a polarization, and an optical orbital angular momentum, for example. Such modulation can further comprise modulation of a beam spot size, a tilt angle and a field of view of the optical beam, as well as to be configured to shift a directionality of the beam from the optical phase array.

The specific (of the overall) beam characteristics may optionally be independently and/or collectively modified by multiple phase masks 121. The phase masks may have the same, similar or distinct functionalities to define the intended optical beam characteristics. The characteristics may be sequentially modified as the optical beam traverses through the phase mask stack layer by layer. Each of the phase masks may have various attributes that can be combined in multiple ways to provide enhanced characteristics of the beam. The various dimension of the optical phase masks, including the height of the core, a thickness or diameter of the core, is selected based on intended phase shift at the particular position on the phase mask.

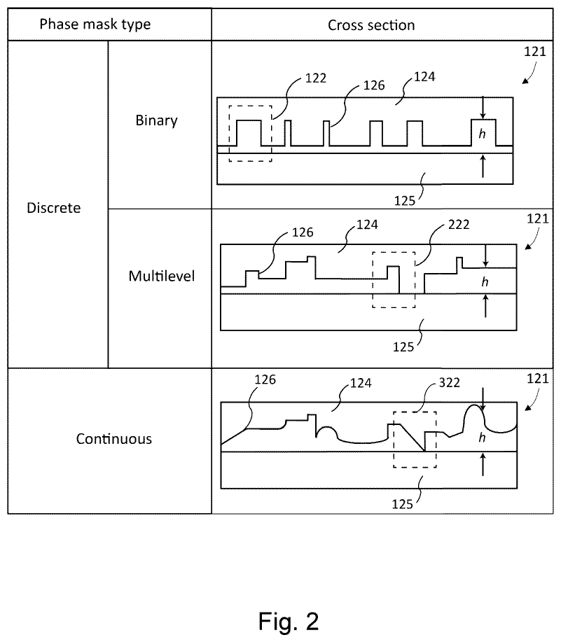

FIG. 2 is a table showing the different types of optical phase masks, discrete and continuous phase masks, and binary and multilevel. Preferably at least a pair of optical phase masks are used in the optical beam sculpting assemblies disclosed herein, and each mask may be of a different type. The discrete binary (i.e., core having two discrete levels of height) optical phase masks 121 are shown with a phase mask unit cell 122 formed with a core, in this case a pillar 126 having a height h and a thickness (or diameter when shaped as a pillar with a generally circular cross-section), and having a distance between pillars. In this embodiment the pillars are surrounded by an undercladding 125 and an overcladding 124, with the core extending from the undercladding to the overcladding by the height. The undercladding 125 and overcladding 124 form part of each unit cell and may each comprise one or more standard photonic materials such as Si, polysilicon, Si₃N₄, Ge, Li₃NbO₃ a polymer, and a III-V compound. Each of the cores corresponding to an array of unit cells are separated by either a uniform distance (to form a symmetrical array) and a non-uniform distance. Phase mask stacking can be obtained using an overcladding which is an undercladding for the next layer of optical phase masks. The thickness of the overcladding can be, for example 0.01 μm to 5 μm. In the binary optical phase mask, the height of each pillar is uniform, but the thickness and distance between each pillar may vary. Such photonic components with discrete core height, fixed overcladding and undercladding thicknesses are advantageous when we need a commercially scalable and economically sustainable mass production of the beam sculpting assembly, as they can be conveniently fabricated layer-by-layer using standard fabrication techniques.

Discrete multilevel optical phase masks 221 are the more general example of discrete optical phase masks where the height, thickness (of the core) and distance between cores can all vary. In the example multilevel phase mask unit cell 222 of FIG. 2, for example, the core can be seen to be formed with non-uniform heights and the distances between the cores of adjacent phase mask unit cells can be non-uniform. Advantageously, such photonic components with discrete multilevel core height can be readily produced using standard fabrication techniques, with greater degrees of freedom to sculpt the beam properties compared to phase masks with discrete binary core height. The sculpted beam enables redefining and modifying the beam characteristics of optical beam from a beam forming and steering structure.

For continuous optical phase masks 321 the height of the core may vary within each unit cells, and between unit cells to form one or more continuous function curves. Height is understood here to mean a distance or length extending above the undercladding, and as shown in FIG. 2 the height may advantageously be non-uniform. Further, in the embodiment of FIG. 2, the unit cell 322 is shown with a series of continuous functions, as well as non-continuous or abrupt changes in phase mask height.

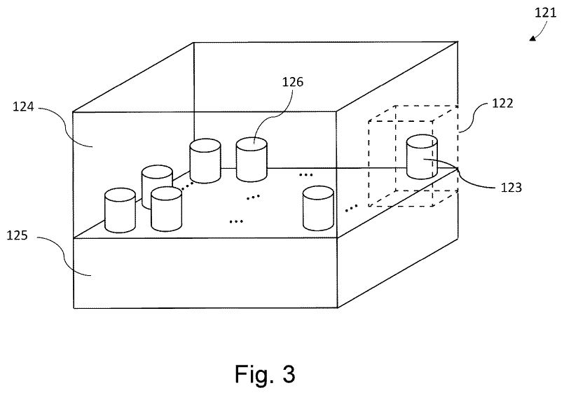

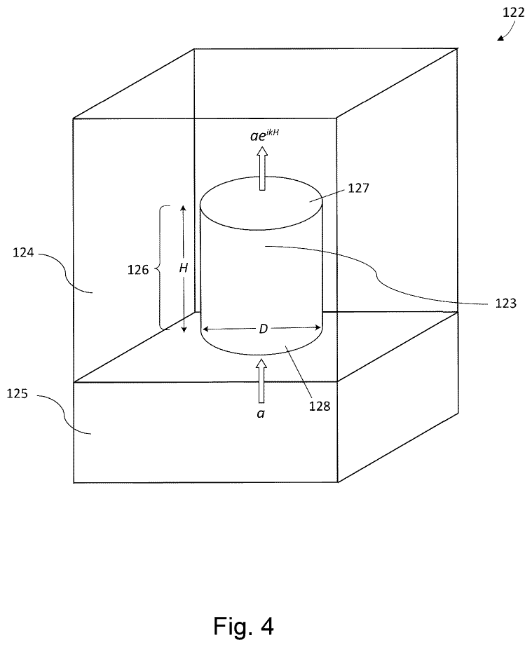

FIG. 3 shows an isometric schematic illustration of the binary phase mask, and FIG. 4 illustrates a unit cell of the binary phase mask of FIG. 3. Phase mask 121 comprises binary phase mask having cylindrical core 126 and phase mask unit cell 122. The distance between adjacent cores of each phase mask unit cell may be arbitrarily chosen, and the dimensions (both height and diameter/diagonal/thickness) of the phase mask unit cell can be based on the intended phase shift at the particular position on the phase mask. The distances between adjacent cores of the phase mask unit cells may be the same or may vary. Optionally, the height of the phase mask unit cell can be between 0.01 μm to 10 μm, and the diameter or cross section of the core of a phase mask unit cell can be between 0.01 μm to 3 μm, and the periodic distance between adjacent phase mask unit cells can be arranged in a square lattice of between 0.01 μm to 3 μm, for example. Lattice refers to regular arrangement of phase mask unit cells, for example triangular, square or hexagonal two-dimensional lattice arrangement of phase mask unit cells. Advantageously, at least one phase mask 121 can be stacked above the beam forming and steering structure, as illustrated in FIG. 1.

An optical phase shift at each periodic lattice point is a function of the dimension of the phase mask unit cell. In one example shown in FIG. 4, the phase mask unit cell core has a cylindrical pillar structure. The phase mask unit cell 122 can be a discrete (binary) phase mask with cylindrical pillar structure of height H introducing the required phase shift. Alternatively, the phase mask unit cell 122 may be multilevel or may have continuous spatial heights. The cylindrical pillar structure 123 shown having an elongate top surface 127, and side walls 128 extending down from the top surface. A refractive index of the cylindrical pillar structure can be larger or smaller than the surrounding cladding. In FIG. 4, the phase mask unit cell 122 introduces an optical phase shift based on its binary-thickness structure. The different optical phase shifts induced by the respective phase mask unit cells 122 at the different points on the phase mask 121—taken together—enables optical beam from beam forming and steering structure to be judiciously sculpted.

In an example, the binary thickness structure of the core 126 of the phase mask unit cell 122 is a cylindrical pillar structure has a thickness of 0.5 μm (consistently discrete). The cylindrical pillar structure is surrounded by the overcladding 124 and the undercladding 125 in the unit cell 122. The phase mask unit cell 122 receives an optical input field of amplitude a. The input optical field a propagates through the unit cell 122, resulting in—by plane-wave approximation, an output optical signal ae^{jkH}, where wavevector k=2πn_{eff}/λ₀, n_{eff} is the effective refractive index of the pillar structure, λ₀ is the wavelength of the optical field.

The optical phase shift at each periodic lattice point, represented by the unit cell illustrated in FIG. 4, can be induced either by modifying k (which is a function of n_{eff}) and/or modifying H. In an example, n_{eff} varies with the diagonal or diameter D of the pillar structure. Advantageously, such pillar structure (which constitute the core) can be produced using standard fabrication techniques, such as lithography and deposition, and comprise standard photonic materials such as Si, polysilicon, Si₃N₄, Ge, Li₃NbO₃ a polymer, a III-V compound. In accordance with an embodiment, the height of each pillar in the phase mask unit cell is fixed based on layer-based deposition or etching process in a conventional semiconductor fabrication process. Advantageously, for the phase mask unit cell 122, a diameter of the pillar structure is a determining factor for introducing an optical phase shift. For example, for a polysilicon cylindrical pillar having 0.5 μm-thickness surrounded by silicon dioxide overcladding and undercladding in the unit cell with 0.65 μm periodic distance between adjacent unit cells, a diameter 0.3575 μm to 0.6175 μm (that is, 0.55 to 0.95 times the periodic distance between adjacent unit cells) induces a monotonically increasing 0 to 2π phase shift. Thus, the intended optical phase shift at any arbitrary point on the phase mask can be designed as per choice based on the relation between the diameter and the induced optical phase shift from the diameter. In a similar manner, for metalenses, a phase profile of the optical beam is transformed based on modulo 2π operation which implies that the radii of the pillar structure in the unit cell change periodically. The phase profile of the optical beam is altered by the phase mask.

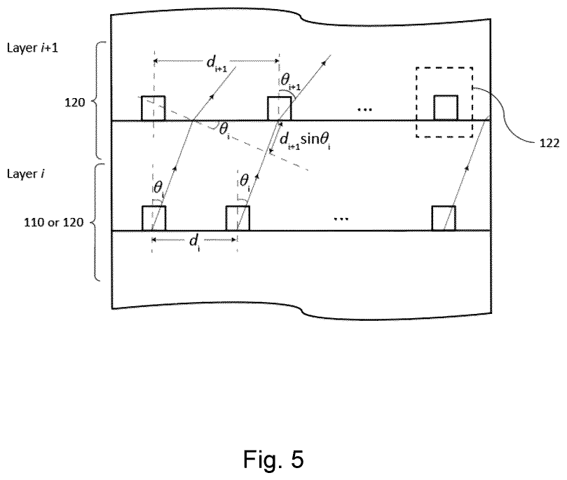

In an embodiment, beam directionality shifting is performed using a phase mask stack mounted above a beam forming and steering structure. In known beam forming and steering structures, wide-angle beam steering may be either unattainable, or require large optical phase shifters which may involve large energy consumption. The change in refractive index to induce optical phase shift required for beam steering in known phase shifters is low (typically about 0.0001 in PN doped phase shifters, and about 0.01 when heated at approximately 100° C. in thermal phase shifters). For PN doped phase shifters, although the waveguide (which forms part of the phase shifters) can be doped with a higher doping dose to further increase the refractive index change (which increases the optical phase shift for beam steering), the increase in doping concentration inevitably increases the optical losses in the doped waveguide, which is undesirable. For thermal phase shifters, although the waveguide (which constitutes the phase shifters) can be heated to a larger extent to further increase the refractive index change, the heat required can be prohibitively high. This too, is undesirable. As a result, long phase shifters (>10 μm) are typically used to compensate the low refractive index change. Such problems can be addressed by implementation of the layer(s) of phase masks being vertically integrated above the beam forming and steering structure (similar to that is illustrated in FIG. 1) to define and modify the spatial distribution of optical amplitude of the optical beam, that is to shift (for example, amplify) the beam directionality in this example. FIG. 5 shows a schematic diagram that illustrates the mechanism of beam directionality shifting using the phase mask stack, where layer i may be any arbitrary layer either from the beam forming and steering structure 110 or phase mask stack 121, for example, phase mask p 121. Layer i+1 is the layer above layer i. The layer i may comprise an array of beam emitters 112 from the beam forming and steering structure, or array of phase mask unit cell 122, while layer i+1 comprise of an array of phase mask unit cell. Layer i may recursively refer to layer i+1 in the iteration before, when multiple phase masks are used for beam directionality shifting.

In FIG. 5, the optical beam from layer i is incident at an angle θi from the vertical axis on the phase mask in layer i+1. As shown, the optical beam then propagates through the phase mask in layer i+1 at a shifted angle θᵢ₊₁ from the vertical axis, where θᵢ₊₁≠θᵢ. The phase mask may comprise a thin layer of phase mask unit cell, the thin layer being judiciously designed and selected for the purpose of shifting the directionality of optical beam. In a preferred embodiment, the thickness of the phase mask unit cell can be 0.01 μm to 5 μm thick to shift the directionality of the optical beam to a specific angle, which may be from 0° to ±180°. In another preferred embodiment, the refractive indices of surrounding layer materials can vary from 1 to 5.

Advantageously, the beam emitters on the beam forming and steering structure and/or phase mask can be periodically placed. The distance between each core of each unit cell, is denoted as d. The beam directionality angle, which is the angle which the optical beam forms with respect to the vertical axis, is denoted as θ. The subscripts of the variables denote the layer on which the unit cell is referred to, for example layer i or i+1.

In FIG. 5, for layer i:

$$Beam directionality : {θ}_{i} = {sin}^{- 1} ( \frac{{λ}_{i , i + 1}}{2 {d}_{i}} \frac{Δ {ϕ}_{i}}{π} ) \qquad ( 1 )$$

where
λ_{i,i+1}=λ₀/n_{i,i+1}, is the effective wavelength of optical field in free-space of the overcladding of layer i (which is the undercladding of layer i+1) with effective refractive index n_{i,i+}1;
   λ₀ is the wavelength of the optical field;
   dᵢ is the distance between centers of neighbouring unit cell in layer i;
Δφᵢ is the optical phase difference of optical field at layer i unit cell

In FIG. 5, for layer i+1:

$$Beam directionality : {θ}_{i + 1} = {sin}^{- 1} ( \frac{{λ}_{i + 1 , i + 2}}{2 {d}_{i + 1}} \frac{{Δϕ}_{i + 1}}{π} ) \qquad ( 2 )$$

where λ_{i+1,i+2}=λ₀/n_{i+1,i+2}, is the effective wavelength of optical field in free-space of the overcladding of layer i+1 (which is the undercladding of layer i+2) with effective refractive index n_{i+1,i+2};
dᵢ₊₁ is the distance between centers of neighbouring unit cell in layer i+1;
Δφᵢ₊₁ is the optical phase difference of optical field at layer i+1 unit cell

Advantageously, by using the pillar structure in FIG. 3 to induce phase shift, the overall phase shift from the structure is Δφᵢ₊₁=Δφᵢ₊₁′+Δφᵢ₊₁″ on layer i+1, write

$${Δφ}_{i + 1}^{′} = \frac{2 π}{{λ}_{i , i + 1}} {d}_{i + 1} sin {θ}_{i}$$

is the optical phase of the field incident onto the unit cell on layer i+1 from layer i; and

$${Δφ}_{i + 1}^{″} = \frac{2 π}{{λ}_{i , i + 1}} {H}_{i + 1}$$

is the optical phase introduced due to unit cell dimensions, assuming the unit cells in layer i+1 are consistently of the same height Hᵢ₊₁.

The beam directionality shift includes, but is not exclusive to, beam directionality amplification. For example, without loss of generality, by considering only one beam forming and steering structure layer (which is i=1), and only one layer of phase mask (P=1, which is i=2), and let θ₁=10°=0.1745 rad.;

$${Δφ}_{1} = 30 ° = π / 6 rad . ;$$

$${n}_{1 , 2} = {n}_{2 , 3} ;$$

$${d}_{1} = {d}_{2} ;$$

the beam directionality from layer 2 (which is from phase mask p=1) is:

$${θ}_{2} = {sin}^{- 1} ( 1 ( 1 sin ( 0.1745 ) + 1 / 6 ) ) ∼ 20 °$$

The addition of phase mask p=1 results in the beam directionality being amplified by about twofold from θ₁=10° to θ₂˜20°. From the above derivations, it can be shown that there are at least one phase mask, that is l>1 (including the beam forming and steering structure layer i=1), where i=1, 2, . . . , l, the beam directionality is amplified by the factor

$${A}_{D} = {\prod }_{i = 2}^{I} \frac{{sin}^{- 1} ( {θ}_{i - 1} + {Δφ}_{i} )}{{θ}_{i - 1}} \qquad ( 3 )$$

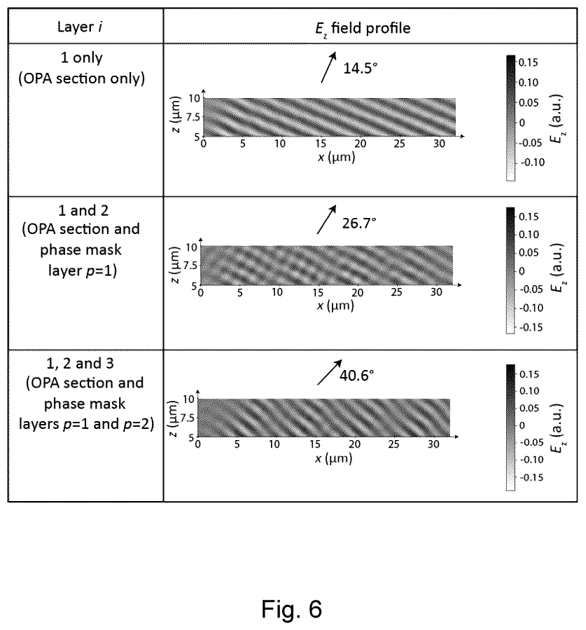

FIGS. 6, 7 and 8 illustrate finite-difference time-domain (FDTD) numerical simulation results for beam directionality shifting using vertical stacking of phase mask stack on OPA (which is a beam forming and steering structure). In one example, the numerically simulated optical beam sculpting assembly has defined parameters, such as 0.5 μm thick cylindrical pillar polysilicon structure as the phase mask unit cell at pitch d=0.65 μm, with radius ranging from (0.275 to 0.475)×d to represent 2π phase shift. Each layer is also provided with an overcladding of 0.25 μm-thick (between the unit cell cores) silicon dioxide, and air in the region beyond the topmost layer overcladding. The beam directionality from OPA is 10°.

FIG. 6 is a table showing numerically simulated resulting z-component of electric field (E_{z}) profiles of embodiments of the photonic components (as described in FIG. 1) at Δφ=30° along an xz-cross section disclosed with different number of phase masks (phase mask p=1 only, layer p=1 and 2, and layer p=1, 2 and 3 in the three examples of the model of FIG. 6). Specifically, along the x-direction from unit cell cₓ=1, 2, . . . , Cₓ (where Cₓ is the total number of unit cells in the x-direction), the radius D/2 of the phase mask unit cell varies according to cₓΔφ (mod 360°)/360°×(0.475−0.275)d+0.275d. The beam direction shifted by the phase mask(s) shown at 14.5°, 26.7°, and 40.6° with phase mask p=1 only, layer p=1 and 2, and layer p=1, 2 and 3 respectively.

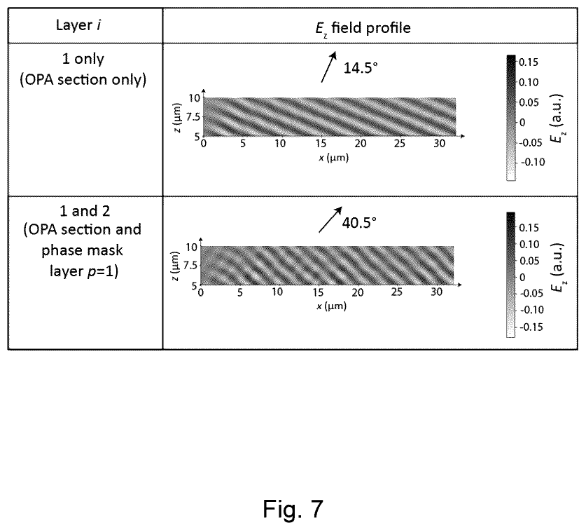

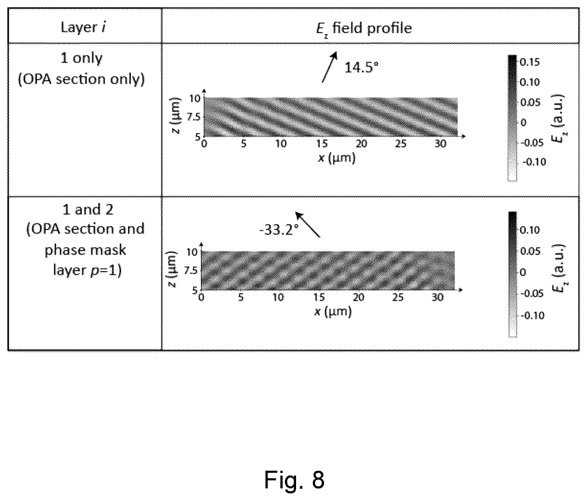

FIG. 7 is another table similar to FIG. 6, but with an estimated resulting z-component of electric field (E_{z}) field profiles of additional embodiments of the photonic components at Δφ=60° along an xz-cross section disclosed with different number of phase masks (phase mask p=1 only, and layer p=1 and 2 in the two examples of the model of FIG. 7). Specifically, along the x-direction from unit cell cₓ=1, 2, . . . , Cₓ (where Cₓ is the total number of unit cells in the x-direction), the radius D/2 of the phase mask unit cell varies according to cₓΔφ (mod) 360°/360°×(0.475−0.275)d+0.275d. The beam direction shifted by the phase mask(s) shown at 14.5°, and 26.7°, and 40.5° with phase mask p=1 only, and layer p=1 and 2 respectively. FIG. 8 is another table similar to FIG. 6, but with an estimated resulting z-component of electric field (E_{z}) field profiles of additional embodiments of the photonic components at Δφ=−120° along an xz-cross section disclosed with different number of phase masks (phase mask p=1 only, and layer p=1 and 2 in the two examples of the model of FIG. 8). Specifically, along the x-direction from unit cell cₓ=1, 2, . . . , Cₓ (where Cₓ is the total number of unit cells in the x-direction), the radius D/2 of the phase mask unit cell varies according to cₓΔφ (mod) 360°/360°×(0.475−0.275)d+0.275d. The beam direction shifted by the phase mask(s) shown at 14.5°, and −33.2° with phase mask p=1 only, and layer p=1 and 2 respectively.

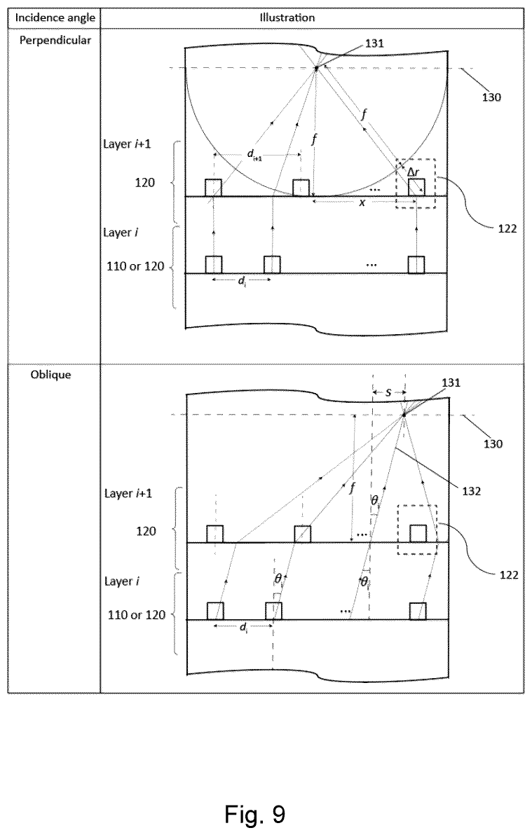

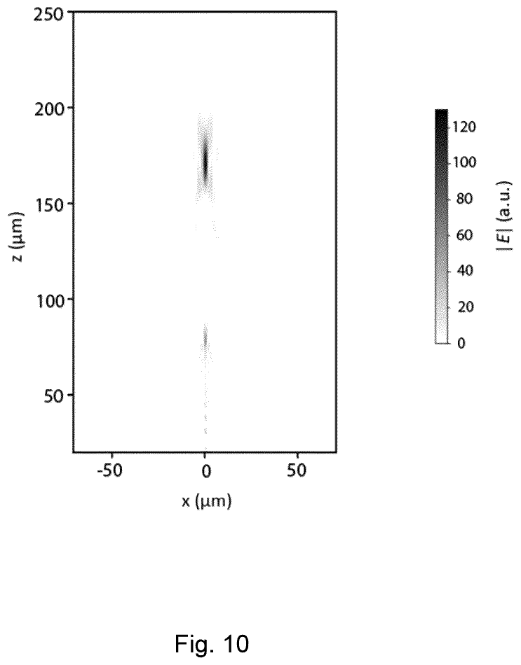

In known beam forming and steering structure, the spatial concentration of optical beam in the far field extends within a certain angle Δθ_{ff} due to Fraunhofer diffraction. The resulting spatial width of the far field beam is given by 2L tan (Δθ_{ff}) where L is the distance between the beam forming and steering structure and the detection or measurement plane. It is evident from this expression that the spatial width of the far field beam increases with increasing L. This indicates beam divergence. Advantageously, embodiments disclosed herein also address the aforementioned beam divergence problem by providing additional layer(s) of phase masks being vertically integrated above the beam forming and steering structure layer (similar to that is illustrated in FIG. 1) to spatially focus the optical beam to a single point at a predetermined or adjustable focal distance. FIGS. 9 and 10 illustrate the use of phase mask for beam focusing. FIG. 9 is a table showing schematic diagrams that illustrate the mechanism of beam focusing using phase mask stack, in accordance with an embodiment disclosed herein at perpendicular and oblique optical beam incidence.

Layer i may be any arbitrary layer and can be from beam forming and steering structure 110 or phase mask stack 121, for example, phase mask p 121. Layer i+1 is the layer above layer i. The layer i may comprise an array of beam emitters 112 from the beam forming and steering structure or array of phase mask unit cell 122, while layer i+1 comprises an array of phase mask unit cell.

In FIG. 9, the optical beam from layer i is incident at an angle θᵢ from the vertical axis on the phase mask on layer i+1. As shown, the optical field of the beam at different points then propagates through the phase mask in layer i+1 at a shifted angle from the vertical axis for focusing at a focal length f, with a focal plane 130, a focal point 131 and an optical axis 132. For oblique optical field incidence from layer i, the horizontal shift s from the focus point 131 of perpendicular optical field incidence (from layer i) is s=f sin(θᵢ). The phase mask may comprise a thin layer of phase mask unit cell for focusing the optical beam. In a preferred embodiment, the thickness of the phase mask unit cell can be 0.01 μm to 5 μm thick to shift the directionality of the optical beam to a specific angle. In another preferred embodiment, the refractive indices of surrounding layer materials can range from 1 to 5.

Advantageously, the beam emitters on the beam forming and steering structure and/or phase mask unit cell can be periodically placed. The distance between each unit cell, is denoted as d. The beam directionality angle, which is the angle from which the optical beam forms with respect to the vertical axis, is denoted as θ. The subscripts of the variables denote the layer on which the unit cell is referred to, for example layer i or i+1.

The phase mask for beam focusing is provided by designing such that optical phase of each horizontally adjacent phase mask unit cell is shifted by

$${Δφ}_{i + 1} = \frac{2 π}{{λ}_{i + 1 , i + 2}} Δ r \qquad ( 4 )$$

where Δr=\sqrt{x²+f²}−f for line focus and Δr=\sqrt{x²+y²+f²}−f for point focus;
x is a distance that corresponds to Δr

In one example, the numerically simulated optical beam sculpting assembly has defined parameters, such as a 0.4 μm thick cylindrical pillar polysilicon structure as the phase mask unit cell at d=0.75 μm pitch, with radius ranging from (0.05 to 0.5)×d to represent 2π phase shift. The specific radius of the cylindrical pillars in each phase mask unit cell is based on Equation (4) with f=170 μm. Layer i=1 (beam forming and steering structure section) is provided with an overcladding of 0.25 μm-thick (between the unit cell cores) silicon dioxide, while layer i=2 (that is layer p=1; topmost layer) is provided an air overcladding. FIG. 10 shows an estimated resulting electric field magnitude of the optical field from the optical beam sculpting assembly.

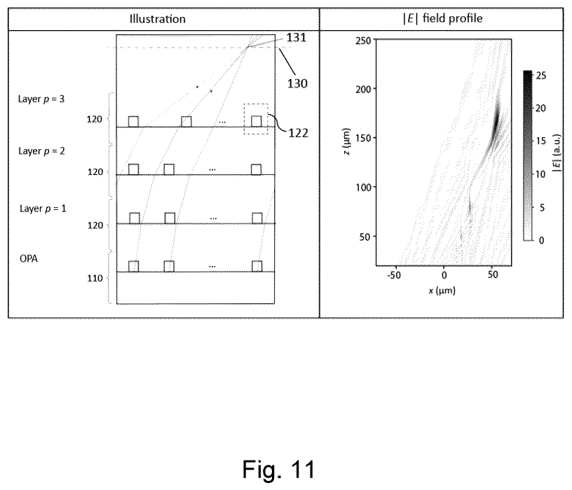

The phase mask stack 120 may include phase masks with the same and/or distinct functionalities to simultaneously achieve the same, similar or distinct functionalities to modify the beam characteristics. For example, the phase mask stack 120 that comprises layers with beam directionality amplification (θᵢ₊₁>θᵢ) and beam focusing functionalities can be combined, with an example shown in FIG. 11. The numerically simulated optical beam sculpting assembly has defined parameters. The parameters are determined based on a relation between the diameter of the cylindrical pillar, at a consistently fixed height, in the unit cell and the induced optical phase shift of the optical field when an optical field propagates through the unit cell. For the layers for beam directionality (p=1 and p=2): 0.5 μm thick cylindrical pillar polysilicon structure as the phase mask unit cell at d=0.65 μm pitch, with radius ranging from (0.275 to 0.475)×d to represent 2π phase shift. Each layer is also provided with an overcladding of 0.25 μm-thick (between the unit cell cores) silicon dioxide. The beam directionality from OPA is 10°, while the diameter of each adjacent unit cell in layers p=1 and p=2 are designed to provide overall beam directionality of 12.4°. For the layer for beam focusing (p=3): 0.5 μm thick cylindrical pillar silicon nitride structure as the phase mask unit cell at pitch d=0.8 μm pitch, with radius ranging from (0.125 to 0.5)×d to represent 2π phase shift. The specific radius of the cylindrical pillars in each phase mask unit cell is based on Equation (4) with f=170 μm. Layer p=3 is provided with an air overcladding. FIG. 11 is a table showing a schematic diagram of a combination of beam directionality shifting and beam focusing, and an estimated resulting electric field magnitude of the optical field from the optical beam sculpting assembly, in accordance with an embodiment of the photonic components disclosed herein.

Thus, the devices disclosed herein are scalable and provide flexibility in vertically integrating optical phase masks on the beam forming and steering structure, and use discretized phase shift unit cells (that is, phase mask unit cells) to modify the beam characteristics from the beam forming and steering structure. Different phase masks having the same, similar or distinct functionalities which can be used by vertically integrating them above the beam forming and steering structure thereby achieve multifunctional layers (feature integration) on a single integrated platform.

Further, the beam forming and steering structure with vertically stacked phase masks is compact, and integration is fully achieved on the chip substrate of the optical beam sculpting assembly. The phase masks can also be positioned precisely via chip design without requiring any mechanical positioning thereby enabling a robust system less prone to mechanical errors. The beam forming and steering structure is also cost-efficient as the platform is integrated entirely on chip and additional phase masks can be conveniently added using the same fabrication steps. Such convenience to fabricate additional phase masks enables bulk production of such devices thereby improving cost efficiency.

From the foregoing disclosure and detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An optical beam sculpting assembly which defines at least one optical beam characteristic of the optical beam, comprising, in combination:
a chip substrate;
a beam forming and steering structure positioned on the chip substrate, adapted to emit, to receive, and to steer the optical beam; and
at least one phase mask, with each phase mask having at least one corresponding core having a thickness, and a height which are selected and configured to induce an intended phase shift at each phase mask,
wherein the beam forming and steering structure is positioned between the at least one phase mask and the chip substrate,
wherein the at least one phase mask is configured to sculpt the optical beam emitted from the beam forming and steering structure by modifying the at least one optical beam characteristic of the optical beam,
wherein the at least one optical beam characteristic comprises at least one of a spatial distribution of optical amplitude, a temporal distribution of the optical amplitude, an optical phase, a polarization, and an optical orbital angular momentum,
wherein a phase profile of the optical beam is transformed based on a modulo 2π operation, wherein the modulo 2π phase shift is a function of the thickness of the core in a phase mask unit cell.

2. The optical beam sculpting assembly of claim 1, wherein the at least one phase mask each comprises one of Si/SiO₂, polysilicon, SiN₄, SiO₂, Ge, Li₃NbO₃, a polymer, a III-V compound and a II-VI compound.

3. The optical beam sculpting assembly of claim 1, wherein each of the phase masks comprises one of a discrete optical phase mask and a continuous optical phase mask.

4. The optical beam sculpting assembly of claim 3 wherein the discrete optical phase mask comprises one of a binary optical phase mask and a multilevel optical phase mask.

5. The optical beam sculpting assembly of claim 1, wherein each of the phase masks modulates at least one of a beam spot size, a tilt angle and a field of view of the optical beam.

6. The optical beam sculpting assembly of claim 1, wherein each of the phase masks is configured to shift a directionality of the beam from the beam forming and steering structure.

7. The optical beam sculpting assembly of claim 1, wherein each phase mask comprises an undercladding and an overcladding, and the core extends from the undercladding toward the overcladding by the height.

8. The optical beam sculpting assembly of claim 7, wherein each phase mask comprises a plurality of unit cells formed as an array, each with one of the corresponding cores, with each of the corresponding cores separated by one of a uniform distance and a non-uniform distance.

9. The optical beam sculpting assembly of claim 7, wherein each core has one of an elliptical, a polygonal, and a closed Bezier curve cross-section.

10. The optical beam sculpting assembly of claim 1, wherein each of the phase masks has same height.

11. The optical beam sculpting assembly of claim 1, wherein the at least one phase mask includes at least two phase masks positioned above the beam forming and steering structure on the chip substrate, wherein each of the at least two phase masks modulates at least one of a beam spot size, a beam tilt angle or directionality and a field-of-view of the beam.

12. (canceled)

13. The optical beam sculpting assembly of claim 1, wherein the at least one phase mask comprises periodically placed unit cells, each with a corresponding core having a non-uniform height.
